(19) United States
(12) Patent Application Publication
(10) Pub. No.: US 2026/0079370 A1
(43) Pub. Date: Mar. 19, 2026

(54) ELECTRONIC SUBSTRATE AND METHOD OF MANUFACTURING THE SAME

(71) Applicant: InnoLux Corporation, Miao-Li County (TW)

(72) Inventors: Jhe-Ciou JHU, Miao-Li County (TW); Yung-Hsiang HSU, Miao-Li County (TW); Fu-Yuan HSIAO, Miao-Li County (TW); Tong-Jung WANG, Miao-Li County (TW)

(73) Assignee: InnoLux Corporation, Miao-Li County (TW)

(21) Appl. No.: 19/298,205

(22) Filed: Aug. 13, 2025

(30) Foreign Application Priority Data
Sep. 13, 2024 (CN) 202411284161.8
May 9, 2025 (CN) 202510593994.0

(51) Int. Cl. G02F 1/1362; G02F 1/1343

(52) U.S. Cl. CPC G02F 1/136277; G02F 1/13439; G02F 1/136286

(57) ABSTRACT

An electronic substrate and a method of manufacturing the same are provided. The electronic substrate includes a substrate, a transistor, a data line, and a conductive element. The transistor is disposed on the substrate, and the transistor includes an active layer, a source, a drain, and a gate disposed on the active layer, in which the active layer is disposed between the source and the drain and overlaps the gate, and the active layer, the source, and the drain are formed of a semiconductor material layer. The data line is disposed on the substrate and electrically connected to the transistor. The conductive element is disposed on the data line and the semiconductor material layer and electrically connected to the data line and the source.

### BACKGROUND OF THE DISCLOSURE

### 1. Field of the Disclosure

The present disclosure relates to an electronic substrate and a method of manufacturing the same and particularly to an electronic substrate including a transistor and a method of manufacturing the same.

### 2. Description of the Prior Art

With the development of technology, displays have become ubiquitous electronic devices, and a common driving method is to drive pixels to display images by an active array circuit. However, a method of manufacturing the array circuit in the prior art requires multiple photolithographic processes in combination with corresponding photomasks, and for example, requires more than 9 photomasks. Also, each photomask is expensive, so that the manufacturing cost of the display is limited by the cost of the photomasks and cannot be effectively reduced. In addition, as the resolution of the display is increased, the number of signal lines in the array circuit needs to be increased. However, in order to maintain the aperture ratio, the line width of each signal line needs to be reduced, resulting in the signal lines prone to breakage.

### SUMMARY OF THE DISCLOSURE

It is one of the objectives of the present disclosure to provide an electronic substrate and a method of manufacturing the same to reduce the number of photomasks and/or avoid the breakage of signal lines.

According to some embodiments of the present disclosure, an electronic substrate is provided and includes a substrate, a transistor, a data line, and a conductive element. The transistor is disposed on the substrate, and the transistor includes an active layer, a source, a drain, and a gate disposed on the active layer, wherein the active layer is disposed between the source and the drain and overlaps the gate, and the active layer, the source, and the drain are formed of a semiconductor material layer. The data line is disposed on the substrate and electrically connected to the transistor. The conductive element is disposed on the data line and the semiconductor material layer and electrically connected to the data line and the source.

According to some embodiments of the present disclosure, a method of manufacturing an electronic substrate is provided. First, a substrate is provided, and a first metal layer is formed on the substrate, wherein the first metal layer includes a data line. Later, a first insulating layer is formed on the first metal layer, and a semiconductor material layer is formed on the first insulating layer. Afterwards, a second insulating layer is formed on the semiconductor material layer, and a second metal layer is formed on the second insulating layer, wherein the second metal layer includes a scan line, and the scan line includes a gate. Then, a source and a drain are formed in the semiconductor material layer, wherein the semiconductor material layer includes an active layer, and the active layer is disposed between the source and the drain. In a cross-sectional view of the electronic substrate, the gate overlaps the active layer, and the scan line is disposed on the data line.

In the electronic substrate and the method of manufacturing the same of the present disclosure, since the active layer, the source, and the drain are formed of the same semiconductor material layer, no extra metal layer is required to form the source and drain, thereby reducing the number of the photomasks or the manufacturing cost.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a top view of an electronic substrate according to a first embodiment of the present disclosure.

FIG. 2 schematically illustrates a cross-sectional view taken along a sectional line A-A′ of FIG. 1.

FIG. 3 schematically illustrates a top view of an electronic substrate according to a second embodiment of the present disclosure.

FIG. 4 schematically illustrates a cross-sectional view taken along a sectional line B-B′ of FIG. 3.

FIG. 5 schematically illustrates a top view of an electronic substrate according to a third embodiment of the present disclosure.

FIG. 6 schematically illustrates a cross-sectional view taken along a sectional line C-C′ of FIG. 5.

FIG. 7 schematically illustrates a top view of an electronic substrate according to a fourth embodiment of the present disclosure.

FIG. 8 schematically illustrates a cross-sectional view taken along a sectional line D-D′ of FIG. 7.

FIG. 9 schematically illustrates a top view of an electronic substrate according to a variant embodiment of the fourth embodiment of the present disclosure.

FIG. 10 schematically illustrates a top view of an electronic substrate according to a fifth embodiment of the present disclosure.

FIG. 11 schematically illustrates a top view of an electronic substrate according to a sixth embodiment of the present disclosure.

FIG. 12 schematically illustrates a cross-sectional view of an electronic substrate according to a seventh embodiment of the present disclosure.

### DETAILED DESCRIPTION

The contents of the present disclosure will be described in detail with reference to specific embodiments and drawings. It is noted that, for purposes of illustrative clarity and being easily understood by the readers, the following drawings may be simplified schematic diagrams, and elements therein may not be drawn to scale. The numbers and sizes of the elements in the drawings are just illustrative and are not intended to limit the scope of the present disclosure.

Certain terms are used throughout the specification and the appended claims of the present disclosure to refer to specific elements. Those skilled in the art should understand that electronic equipment manufacturers may refer to an element by different names, and this document does not intend to distinguish between elements that differ in name but do not function.

In the following specification and claims, the terms “comprise”, “include” and “have” are open-ended fashion, so they should be interpreted as “including but not limited to . . . ”.

The ordinal numbers used in the specification and the appended claims, such as “first”, “second”, etc., are used to describe the elements of the claims. It does not mean that the element has any previous ordinal numbers, nor does it represent the order of a certain element and another element, or the sequence in a manufacturing method. These ordinal numbers are just used to make a claimed element with a certain name be clearly distinguishable from another claimed element with the same name.

Spatially relative terms, such as “above”, “on”, “beneath”, “below”, “under”, “left”, “right”, “before”, “front”, “after”, “behind” and the like, used in the following embodiments just refer to the directions in the drawings and are not intended to limit the present disclosure.

In addition, when one element or layer is “on” or “above” another element or layer or is “connected to” the another element or layer, it may be understood that the element or layer is directly on the another element or layer or directly connected to the another element or layer, and alternatively, another element or layer may be between the element or layer and the another element or layer (indirectly). On the contrary, when the element or layer is “directly on” the another element or layer or is “directly connected to” the another element or layer, it may be understood that there is no intervening element or layer between the element or layer and the another element or layer.

The term “electrically connected to” includes any direct or indirect means of electrical connection. Two elements electrically connected to each other may be referred to as being in direct contact with each other to transmit electrical signals with no intervening element between them. Alternatively, two elements electrically connected to each other may be bridged by another element between them to transmit electrical signals. The term “coupled to” as disclosed herein may be referred to as “electrically connected to”.

As disclosed herein, the terms “approximately”, “essentially”, “about”, or “substantially” generally mean within 10%, 58, 3%, 2%, 1%, or 0.5% of the reported numerical value or range.

It should be understood that according to the following embodiments, features of different embodiments may be replaced, recombined or mixed to constitute other embodiments without departing from the spirit of the present disclosure. The features of various embodiments may be mixed arbitrarily and used in different embodiments without departing from the spirit of the present disclosure or conflicting.

In the present disclosure, the length, thickness, width, height, distance, and area may be measured by using an optical microscope (OM), a scanning electron microscope (SEM) or other approaches, but not limited thereto.

Unless otherwise defined, all terms (including technical and scientific terms) used herein have the same meaning as commonly understood by those skilled in the art. It should be understood that these terms, such as those defined in commonly used dictionaries, should be interpreted as having meaning consistent with the relevant technology and the background or context of the present disclosure, and should not be interpreted in an idealized or excessively formal way, unless there is a specific definition in the embodiments of the present disclosure.

An electronic substrate of the present disclosure may, for example, be applied to any kind of electronic device. The electronic device may, for example, include a display device, a light emitting device, a sensing device, an antenna device, a touch device, a tiling device, or other suitable electronic devices, but not limited thereto. The electronic device of the present disclosure may, for example, be a bendable, stretchable, foldable, rollable, and/or flexible electronic device, but not limited thereto. The display device may, for example, be applied to laptop, public display, tiling display, display for car, touch display, television, monitor, smartphone, tablet, light source module, illumination apparatus, military equipment, or any electronic device applied to the aforementioned product, but not limited thereto. The display device may include liquid crystal molecules, a light emitting diode, a color conversion layer, other suitable display media, or combinations thereof, but not limited thereto. The light emitting diode may, for example, include an organic light emitting diode (OLED), a mini light emitting diode (mini LED), a micro light emitting diode (micro LED), or a quantum dot light emitting diode (e.g., also called QLED or QDLED), but not limited thereto. The color conversion layer may include a wavelength conversion material and/or color filter material, and for example, the color conversion layer may include a fluorescent material, a phosphorescent material, quantum dot (QD), other suitable materials, or combinations thereof, but not limited thereto. The display device may include liquid crystal device, electro-phoretic display device, or other suitable devices, but not limited thereto. The sensing device may, for example, be a sensing device used for detecting variation in capacitances, light, heat, or ultrasound, but not limited thereto. The sensing device may, for example, include a biosensor, a touch sensor, a fingerprint sensor, other suitable sensors, or any combination of sensors mentioned above. The antenna device may, for example, include liquid crystal antenna or antennas of other types, but not limited thereto. The tiling device may, for example, include a tiling display device or a tiling antenna device, but not limited thereto. Furthermore, the appearance of the electronic device may be, for example, rectangular, circular, polygonal, a shape with curved edges, curved or other suitable shapes. The electronic device may have peripheral systems such as a driving system, a control system, a light source system, a shelf system, etc. The electronic device may include electronic units, in which the electronic units may include a passive element and an active element, and for example include a capacitor, a resistor, an inductor, a diode, a transistor, a sensor, etc. It is noted that the electronic device of the present disclosure may be any combination of the above-mentioned devices, but not limited thereto. The electronic substrate in the following contents takes an array substrate of the liquid crystal display panel as an example, but the present disclosure is not limited thereto. In some embodiments, the electronic substrate may be used as an array substrate of a sensing panel or other devices.

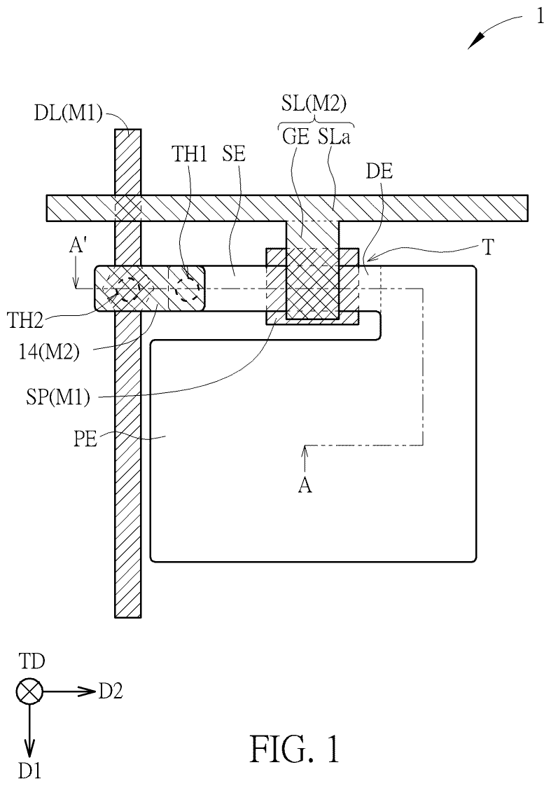

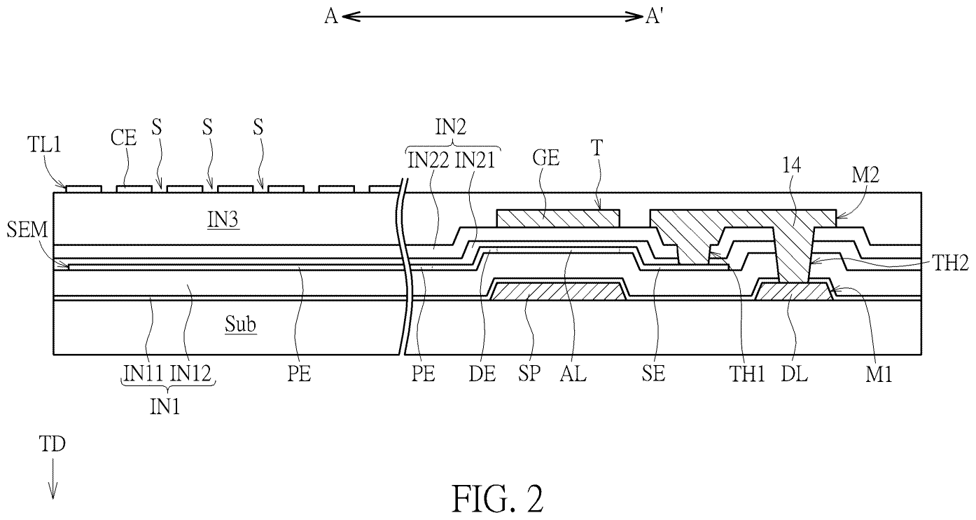

FIG. 1 schematically illustrates a top view of an electronic substrate according to a first embodiment of the present disclosure, and FIG. 2 schematically illustrates a cross-sectional view taken along a sectional line A-A′ of FIG. 1. As shown in FIG. 1 and FIG. 2, the electronic substrate 1 includes a substrate Sub, a transistor T, a data line DL, and a conductive element 14, wherein the transistor T and the data line DL are disposed on the substrate Sub. The transistor T includes an active layer AL, a source SE, a drain DE, and a gate GE disposed on the active layer AL, wherein the active layer AL is disposed between the source SE and the drain DE and overlaps the gate GE, and the active layer AL, the source SE, and the drain DE are formed of same semiconductor material layer SEM. The data line DL is disposed on the substrate Sub and electrically connected to the transistor T. The conductive element 14 is disposed on the data line DL and the semiconductor material layer SEM and is connected to the data line DL and the source SE. Since the active layer AL, the source SE, and the drain DE are formed of the same semiconductor material layer SEM, there is no need to form the source SE and the drain DE through an extra metal layer, thereby facilitating reduction of the number of photomasks or manufacturing costs.

Specifically, in this embodiment, the electronic substrate 1 may include a first metal layer M1, an insulating layer IN1, the semiconductor material layer SEM, an insulating layer IN2, a second metal layer M2, an insulating layer IN3, and a transparent conductive layer TL1, which are sequentially disposed on the substrate Sub. The substrate Sub may include, for example, a flexible substrate or an inflexible substrate. The substrate Sub may include, for example, glass, ceramic, quartz, sapphire, acrylic, polyimide (PI), polyethylene terephthalate (PET), polycarbonate (PC), polyethersulfone (PES), polybutylene terephthalate (PBT), polyethylene naphthalate (PEN) or polyarylate (PAR), other suitable materials or combinations thereof, but not limited thereto.

In the embodiment of FIG. 1 and FIG. 2, the first metal layer M1 may include a signal line extending along a first direction D1, but not limited thereto. The signal line may be, for example, a data line DL, and in other words, the data line DL may be formed of the first metal layer M1. In other embodiments, the data line DL may be formed of other metal layers. The first metal layer M1 may, for example, directly contact an upper surface of the substrate Sub. Since the upper surface of the substrate Sub may be flat, forming the signal line directly on the upper surface of the substrate Sub may help reduce or avoid uneven etching of the signal line due to being formed on uneven surface. Consequently, the risk of the signal line breakage may be lowered to improve product yield in the case that the line width of the signal line is reduced.

The first metal layer M1 may further include a light shielding pattern SP, which is disposed between the substrate Sub and the active layer AL and overlaps the active layer AL. The light shielding pattern SP may be used to reduce the influence of light exposure on the active layer AL, such that the transistor T is able to operate normally. For example, an area of the light shielding pattern SP may be greater than an area of the active layer AL or an area of the semiconductor material layer SEM overlapping the gate GE. The first metal layer M1 may be a single-layer or multi-layer structure. The first metal layer M1 may, for example, include molybdenum nitride, copper, other suitable materials, or combinations thereof. Since the data line DL and the light shielding pattern SP may be formed of the same first metal layer M1, compared to the case that the data line DL and the light shielding pattern SP are formed of different metal layers, this embodiment may save a photomask and a photolithographic process, thereby reducing the manufacturing cost.

In some embodiments, the gate GE may be electrically connected to the light shielding pattern SP, so that the light shielding pattern SP may be used as another gate of the transistor T. In this case, the transistor T may be a double-gate type transistor, but not limited thereto. In other embodiments, the light shielding pattern SP may alternatively provide a voltage different from gate voltage for adjusting bias voltage.

The insulating layer IN1 may be disposed on the first metal layer M1 and used to reduce the influence of moisture or gas (e.g., oxygen) on the semiconductor material layer SEM. For example, the insulating layer IN1 may include silicon oxide, silicon nitride, other suitable materials, or combinations thereof. In FIG. 2, the insulating layer IN1 may be, for example, a multi-layer structure, for example, including an insulating layer IN11 and an insulating layer IN12 stacked in sequence. The insulating layer IN11 and the insulating layer IN12 may include the same or different materials. In some embodiments, a thickness of the insulating layer IN11 may, for example, be less than a thickness of the insulating layer IN12, wherein the insulating layer IN11 may include silicon nitride, and the insulating layer IN12 may include silicon oxide, but not limited thereto. In this case, the thickness of the insulating layer IN11 may range from about 300 angstroms (Å) to about 800 angstroms, and for example, may be 400 angstroms, 500 angstroms, 600 angstroms, or 700 angstroms, and the thickness of the insulating layer IN12 may range from about 2000 angstroms to about 3500 Å, and for example, may be 2500 angstroms, 2700 angstroms, 3000 angstroms, or 3200 angstroms.

The electronic substrate 1 may further include a pixel electrode PE electrically connected to the transistor T. In the embodiment of FIG. 1, the pixel electrode PE may be formed of the semiconductor material layer SEM and be connected to the drain DE. In other words, the pixel electrode PE and the drain DE may be different portions of the semiconductor material layer SEM connected to each other, but not limited thereto. The semiconductor material layer SEM may include metal oxide or other suitable materials. The metal oxide herein may include indium gallium zinc oxide (IGZO) or other suitable metal oxide semiconductors. In some embodiments, a thickness of the semiconductor material layer SEM may range from about 200 angstroms to 500 angstroms, and for example, may be 250 angstroms, 300 angstroms, 350 angstroms, 400 angstroms, or 450 angstroms.

It should be noted that the pixel electrode PE, the drain DE and the source SE may include dopants and have certain conductivity and a property of conductor. Instead, the active layer AL does not include dopants and has a property of semiconductor, such that the active layer AL is used as a channel layer of the transistor T. In other words, the conductivity of each of the pixel electrode PE, the drain DE and the source SE may be greater than the conductivity of the active layer AL. The dopants may be, for example, a substance produced in the step of forming the insulating layer IN3, wherein the dopants may be, for example, hydrogen or other suitable conductive ions, but not limited thereto. In some embodiments, the dopants may alternatively be other charged ions, for example, implanted into the semiconductor material layer SEM through an ion implanting process, but not limited thereto. Since the pixel electrode PE and the active layer AL may be formed of the same semiconductor material layer SEM, a photomask for individually forming the pixel electrode PE may be saved, thereby reducing the manufacturing cost. In addition, as the semiconductor material layer SEM is formed of metal oxide, the semiconductor material layer SEM has a certain transmittance, such that a portion of the semiconductor material layer SEM may be used as the pixel electrode PE, thereby reducing the influence on the utilization efficiency of the light generated from the backlight module. For example, the transmittance of the pixel electrode PE may be greater than 80%, for example, 85%, 90%, 95%, 99%, or 99.9%. In this case, the electronic substrate 1 may be used as an array substrate of a liquid crystal display panel.

The insulating layer IN2 may be disposed on the semiconductor material layer SEM and may be used as a gate insulating layer of the transistor T. In the embodiment of FIG. 2, the insulating layer IN2 may be a multilayer structure, but not limited thereto. The insulating layer IN2 may, for example, include an insulating layer IN21 and an insulating layer IN22, which are sequentially disposed on the semiconductor material layer SEM. The density of the insulating layer IN21 may be greater than the density of the insulating layer IN22. Forming the insulating layer IN21 and the insulating layer IN22 separately may adjust turn-on voltage of the transistor T. The insulating layer IN21 and the insulating layer IN22 may, for example, include silicon oxide or other suitable insulating materials. The total thickness of the insulating layer IN21 and the insulating layer IN22 may be about 1000 angstroms to 2000 angstroms, and for example, may be 1100 angstroms, 1300 angstroms, 1500 angstroms, 1700 angstroms, or 1900 angstroms.

The second metal layer M2 may be disposed on the insulating layer IN2, and the second metal layer M2 may include the gate GE. In the cross-sectional view of the electronic substrate 1, the gate GE overlaps the active layer AL. In the embodiment of FIG. 2, the gate GE may be formed of the second metal layer M2. The second metal layer M2 may further include a scan line SL, and a portion of the scan line SL may be used as the gate GE. In other words, the scan line SL may include the gate GE. Furthermore, the scan line SL may include a strip portion SLa extending along a second direction D2 different from the first direction D1, and the strip portion SLa connected to the gate GE. The second direction D2 may be, for example, perpendicular or non-perpendicular to the first direction D1. The strip portion SLa of the scan line SL may cross the data line DL and be disposed on the data line DL, but not limited thereto.

In the embodiment of FIG. 2, the second metal layer M2 may further include the conductive element 14 electrically connected to the data line DL and the source SE. For example, the insulating layer IN2 may have a through hole TH1, and the insulating layer IN2 and the insulating layer IN1 may have another through hole TH2, wherein the through hole TH1 overlaps the source SE, and the through hole TH2 overlaps the data line DL. The conductive element 14 may extend into the through hole TH1 and the through hole TH2 to be connected to the data line DL and the source SE. The second metal layer M2 may, for example, include a single layer or multilayer structure. The multilayer structure may, for example, include titanium nitride, copper, copper alloy, other suitable materials, or combinations thereof. The copper alloy may, for example, include molybdenum, titanium, copper, magnesium, aluminum, chromium, other suitable materials, or combinations thereof. In some embodiments, the conductive element 14 may not be formed of the second metal layer M2 but be formed of another conductive layer.

The insulating layer IN3 may be disposed on the second metal layer M2. In one embodiment, the insulating layer IN3 may, for example, have a flat upper surface to facilitate forming the transparent conductive layer TL1 thereon. The insulating layer IN3 may, for example, include an inorganic material, an organic material, or combinations thereof. The inorganic material may, for example, include silicon nitride or other suitable materials. The thickness of the insulating layer IN3 may range from about 2000 angstroms to 3000 angstroms, and for example, may be 2300 angstroms, 2500 angstroms, or 2700 angstroms.

In the embodiment of FIG. 2, the transparent conductive layer TL1 may include a common electrode CE disposed on the insulating layer IN3, and the common electrode CE overlaps the pixel electrode PE in a top-view direction TD of the electronic substrate 1. The common electrode CE may have a plurality of slits S arranged in sequence along a direction. The slits S may be arranged, for example, along the second direction D2, but not limited thereto. The electric field between the pixel electrode PE and the common electrode CE may rotate the liquid crystal molecules on the electronic substrate 1 by the structure of the slits S to present a required grayscale value.

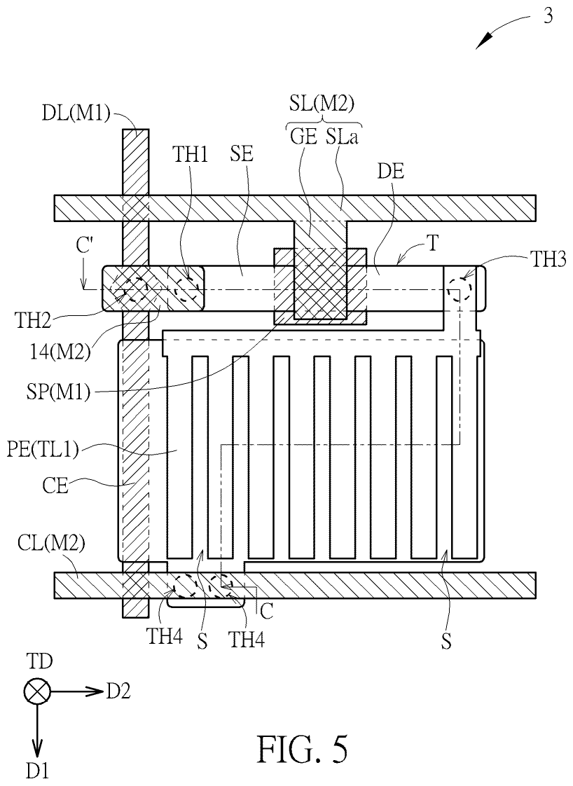

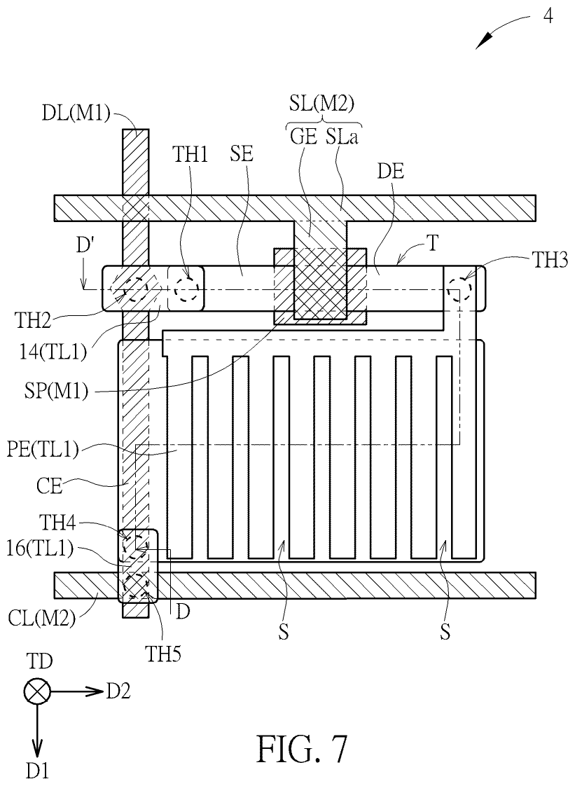

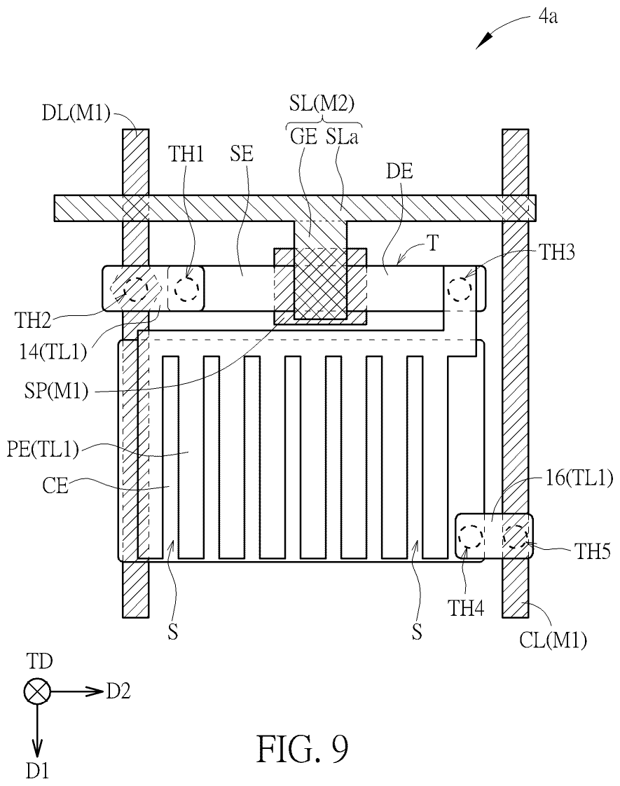

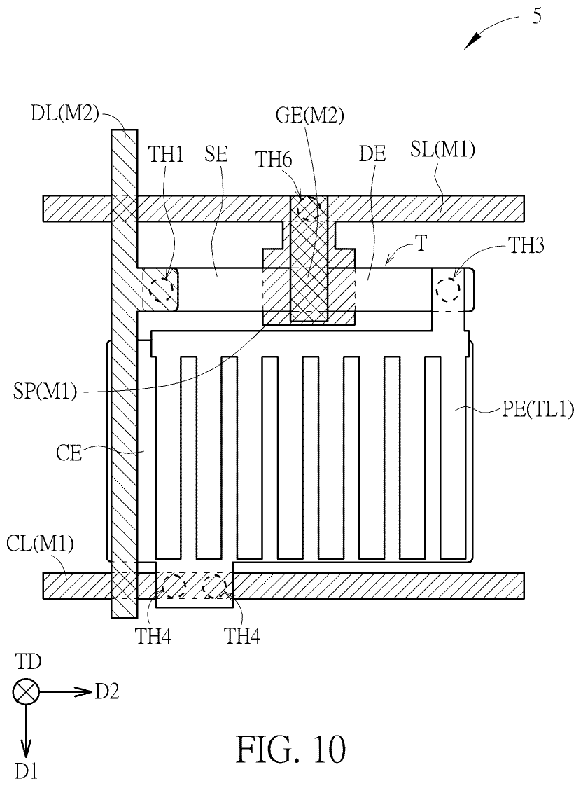

In some embodiments, the first metal layer M1, the second metal layer M2 or the transparent conductive layer TL1 may further include a common line electrically connected to the common electrode CE for transmitting a common voltage signal, but not limited thereto. For example, as the first metal layer M1 includes a common line, FIG. 9 or FIG. 10 may be referred to for the structure of the common line, and as the second metal layer M2 includes a common line, FIG. 5 or FIG. 7 may be referred to for the structure of the common line, but not limited thereto.

Although FIG. 1, FIG. 2 and the following figures show the structure corresponding to a single pixel or a single sub-pixel, that is, showing a data line DL, a scan line SL, a transistor T and a pixel electrode PE, the electronic substrate of the present disclosure is not limited thereto, and may include a plurality of the data lines DL, a plurality of the scan lines SL, a plurality of the transistors T, and a plurality of the pixel electrodes PE.

The method of manufacturing the electronic substrate 1 of this embodiment is further mentioned in the following contents. As shown in FIG. 1 and FIG. 2, the method of manufacturing the electronic substrate 1 may include providing the substrate Sub; forming the first metal layer M1 on the substrate Sub; forming the insulating layer IN1 on the first metal layer M1; forming the semiconductor material layer SEM on the insulating layer IN1; forming the insulating layer IN2 on the semiconductor material layer SEM; forming the second metal layer M2 on the insulating layer IN2; and, forming the source SE and the drain DE in the semiconductor material layer SEM.

Specifically, the method of forming the first metal layer M1 may include forming a metal material on the substrate Sub and then performing a first photolithographic process with a first photomask to pattern the metal material into the first metal layer M1. The method of forming the metal material may, for example, include a deposition process or other suitable processes. In this embodiment, the first metal layer M1 may be directly formed on the upper surface of the substrate Sub. In this way, it may help to reduce line breakage to improve the product yield as the line width of the signal line (e.g., the data line DL) of the first metal layer M1 is reduced.

After the first metal layer M1 is formed, the insulating layer IN1 may be formed on the substrate Sub and the first metal layer M1. The method of forming the insulating layer IN1 may, for example, include performing one or more deposition processes or other suitable processes. The deposition process may, for example, include chemical vapor deposition process, physical vapor deposition process, other suitable deposition processes, or combinations thereof. In the embodiment of FIG. 2, the step of forming the insulating layer IN1 may include sequentially forming the insulating layer IN11 and the insulating layer IN12, but not limited thereto.

Then, the semiconductor material layer SEM is formed on the insulating layer IN1. The method of forming the semiconductor material layer SEM may include blanketly forming a semiconductor material on the insulating layer IN1 and then performing a second photolithographic process with a second photomask to pattern the semiconductor material into the semiconductor material layer SEM. At this time, the semiconductor material layer SEM may have the property of semiconductor, but not the property of conductor.

After the semiconductor material layer SEM is formed, the insulating layer IN2 may be formed on the semiconductor material layer SEM and the insulating layer IN1. In the embodiment of FIG. 2, the step of forming the insulating layer IN2 may include sequentially forming the insulating layer IN21 and the insulating layer IN22. It should be noted that the step of forming the insulating layer IN21 may be slower than the step of forming the insulating layer IN22, such that the step of forming the insulating layer IN21 may be used to form a portion of the insulating layer IN2 with a higher dielectric constant, and the step of forming the insulating layer IN22 may be used to shorten the duration of forming the insulating layer IN2 to form the insulating layer IN2 with a certain thickness. The step of forming the insulating layer IN21 and the step of forming the insulating layer IN22 may include performing deposition processes or other suitable processes.

It should be noted that since hydrogen is generated during the formation of the insulating layer IN21 and the insulating layer IN22, the semiconductor material layer SEM is doped with hydrogen ions during the formation of the insulating layer IN21 and the insulating layer IN22 and has the property of conductor. In order to maintain the property of semiconductor of the semiconductor material layer SEM before forming the source SE and the drain DE, the step of forming the insulating layer IN21 and the step of forming the insulating layer IN22 may each further include an annealing process or other thermal processes after the deposition process to remove the hydrogen ions in the semiconductor material layer SEM.

A third photolithographic process may be performed with a third photomask to form the through hole TH1 in the insulating layer IN2 and the through hole TH2 in the insulating layer IN2 and the insulating layer IN1 between the step of forming the insulating layer IN2 and the step of forming the second metal layer M2.

Subsequently, the method of forming the second metal layer M2 may include blanketly forming a metal material on the insulating layer IN2 and then performing a fourth photolithographic process with a fourth photomask to pattern the metal material into the second metal layer M2. Since the through hole TH1 and the through hole TH2 are formed before the second metal layer M2 is formed, the conductive element 14 of the second metal layer M2 may be formed in the through hole TH1 and the through hole TH2 simultaneously, thereby electrically connecting the data line DL to the source SE of the transistor T. Since the method of forming the second metal layer M2 is similar or identical to the method of forming the first metal layer M1, it will not be described in detail here.

After the second metal layer M2 is formed, the source SE and the drain DE may be formed in the semiconductor material layer SEM. In the embodiment of FIG. 2, the step of forming the source SE and the drain DE may include forming the insulating layer IN3 on the second metal layer M2 and the insulating layer IN2. The method of forming the insulating layer IN3 may include a deposition process or other suitable processes. Since the step of forming the insulating layer IN3 produces dopants, in this step, dopants may be introduced into portions of the semiconductor material layer SEM without overlapping the scan line SL. Accordingly, the portions of the semiconductor material layer SEM has the property of conductor, thereby forming the source SE, the drain DE, and the pixel electrode PE in the semiconductor material layer SEM, but the present disclosure is not limited thereto.

The dopants may be substance used or generated in the step of forming the insulating layer IN3 or ions implanted by an ion implantation process. For example, as the insulating layer IN3 includes silicon nitride, precursors for forming the insulating layer IN3 may include silane and ammonia, so that hydrogen is generated in the step of forming the insulating layer IN3 as the dopants to enter the semiconductor material layer SEM to form the source SE, the drain DE, and the pixel electrode PE.

In addition, although the conductive element 14 overlaps the semiconductor material layer SEM in the top-view direction TD, and it is not easy to directly introduce the dopants, the metal atoms in the conductive element 14 may be diffused into a portion of the semiconductor material layer SEM overlapping the conductive element 14, or the dopants doped into a portion of the semiconductor material layer SEM adjacent to the conductive element 14 may be diffused into the portion of the semiconductor material layer SEM overlapping the conductive element 14, such that the portion of the semiconductor material layer SEM overlapping the conductive element 14 has the property of conductor.

After the insulating layer IN3 is formed, a fifth photolithographic process may be performed with a fifth photomask to form a through hole in the insulating layer IN3 to facilitate electrical connection between the common electrode CE and the common line formed subsequently. The insulating layers penetrated through by the through hole formed by the fifth photolithographic process may be determined according to the position of the layer for forming the common line. For example, as the first metal layer M1 includes the common line, the through hole may penetrate the insulating layer IN1, the insulating layer IN2, and the insulating layer IN3. As the second metal layer M2 includes the common line, the through hole may penetrate the insulating layer IN3.

Then, a transparent conductive layer TL1 is formed on the insulating layer IN3. The step of forming the transparent conductive layer TL1 may include blanketly forming a transparent conductive material on the insulating layer IN3 and then performing a sixth photolithographic process with a sixth photomask to pattern the transparent conductive material into the transparent conductive layer TL1. The transparent conductive material of the transparent conductive layer TL1 may include indium tin oxide (ITO), indium zinc oxide (IZO) or other suitable materials.

As mentioned above, the method of manufacturing the electronic substrate 1 of this embodiment requires 6 photomasks. Therefore, compared to 9 photomasks in the prior art, the structure of the electronic substrate 1 of this embodiment may significantly simplify the manufacturing steps and reduce the number of the used photomasks, thereby reducing the manufacturing cost.

The electronic substrate and the method of manufacturing the same of the present disclosure are not limited to the above-mentioned embodiments and may have other embodiments. To simplify the description, same elements use the same reference characters as the above-mentioned embodiments in following other embodiments. To clearly describe the other embodiments, differences between the other embodiments and the above-mentioned embodiment will be described below, and the repeated parts will not be detailed redundantly.

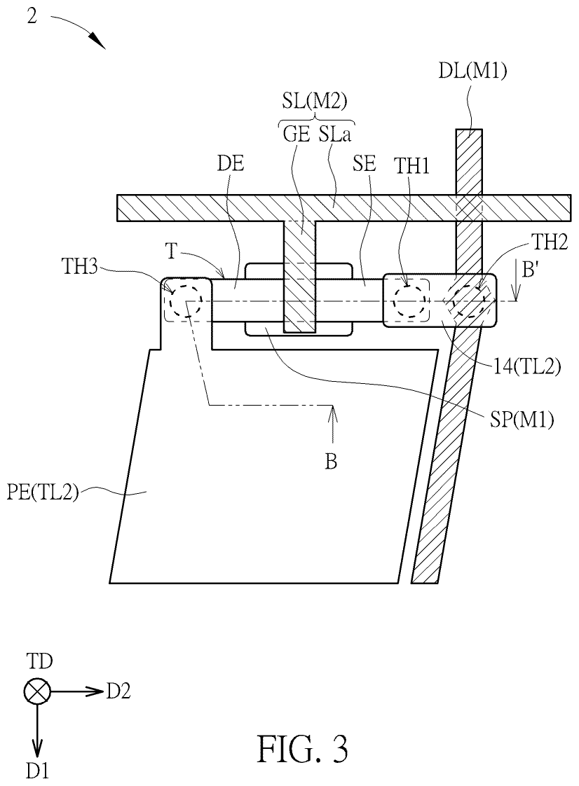

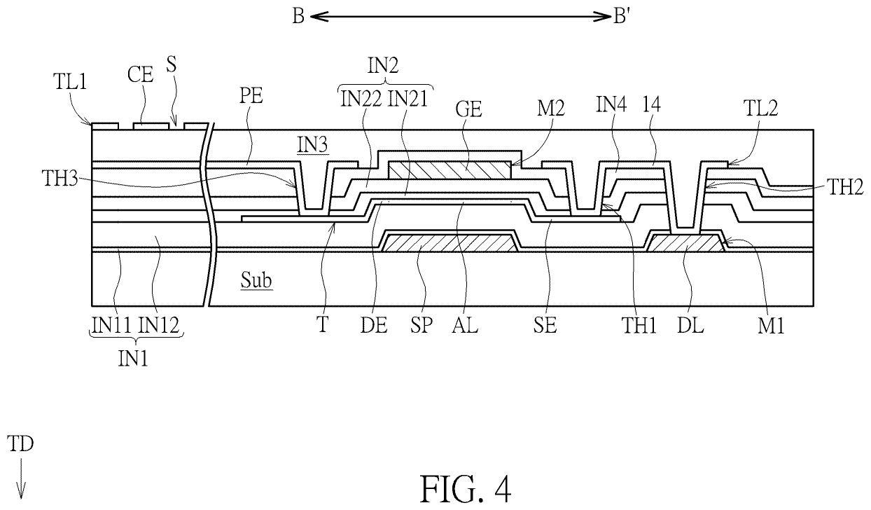

FIG. 3 schematically illustrates a top view of an electronic substrate according to a second embodiment of the present disclosure, and FIG. 4 schematically illustrates a cross-sectional view taken along a sectional line B-B′ of FIG. 3. As shown in FIG. 3 and FIG. 4, the electronic substrate 2 of this embodiment differs from the electronic substrate 1 of FIG. 1 and FIG. 2 in that the electronic substrate 2 may further include an insulating layer IN4 and a transparent conductive layer TL2, and the pixel electrode PE and the conductive element 14 may be formed of the transparent conductive layer TL2. The common electrode CE may still be formed of the transparent conductive layer TL1, and the transparent conductive layer TL1 is disposed on the transparent conductive layer TL2. Specifically, the insulating layer IN4 is disposed between the second metal layer M2 and the insulating layer IN3, and the transparent conductive layer TL2 is disposed between the insulating layer IN4 and the insulating layer IN3. Furthermore, the insulating layer IN2 and the insulating layer IN4 may have the through hole TH1 overlapping the source SE and a through hole TH3 overlapping the drain DE, and the insulating layer IN1, the insulating layer IN2, and the insulating layer IN4 may have the through hole TH2 overlapping the data line DL. The conductive element 14 may extend into the through hole TH1 and the through hole TH2, thereby electrically connecting the source SE to the data line DL. The pixel electrode PE may extend into the through hole TH3, thereby electrically connecting the drain DE. The transparent conductive layer TL2 may include a transparent conductive material that is identical or similar to the transparent conductive layer TL1, for example, indium tin oxide (ITO), indium zinc oxide (IZO) or other suitable materials.

In the embodiment of FIG. 3, at least a portion of the data line DL may not extend along the first direction D1, but an angle less than 90 degrees may be formed between an extension direction of the portion of the data line DL and the first direction D1, but not limited thereto. In some embodiments, the data line DL may alternatively extend along the first direction D1. In some embodiments, the extension direction of the portion of the data line DL of FIG. 3 may be applied to any of the above or following embodiments.

In the method of manufacturing the electronic substrate 2 of this embodiment, the step of forming the insulating layer IN4 may be performed after the second metal layer M2 is formed, and the method of forming the insulating layer IN4 may include a deposition process or other suitable processes. The insulating layer IN4 may, for example, include silicon oxide or other suitable materials. It should be noted that the step of forming the source SE and the drain DE in the semiconductor material layer SEM of this embodiment may be performed simultaneously with the step of forming the insulating layer IN4, but not limited thereto. In addition, the method of forming the source SE and the drain DE is identical or similar to the above-mentioned embodiment, so it is not described in detail here. In the embodiment of FIG. 3 and FIG. 4, the step of forming the source SE and the drain DE may not form the pixel electrode, but not limited thereto.

After the insulating layer IN4 is formed, the third photolithographic process may be performed with the third photomask to form the through hole TH1 and the through hole TH3 in the insulating layer IN4 and the insulating layer IN2 and to form the through hole TH2 in the insulating layer IN4, the insulating layer IN2, and the insulating layer IN1. In this embodiment, the through hole TH1 may expose the source SE, the through hole TH2 may expose the data line DL, and the through hole TH3 may expose the drain DE.

After the through hole TH1, the through hole TH2, and the through hole TH3 are formed, the transparent conductive layer TL2 may be formed on the insulating layer IN4. The method of forming the transparent conductive layer TL2 may include blanketly forming a transparent conductive material layer on the insulating layer IN4 and then performing a seventh photolithographic process with a seventh photomask to pattern the transparent conductive material layer into the pixel electrode PE and the conductive element 14 separated from each other. The pixel electrode PE may be electrically connected to the drain DE through the through hole TH3, and the conductive element 14 may be electrically connected to the source SE and the data line DL through the through hole TH1 and the through hole TH2. Other parts of the electronic substrate 2 and other steps of the method of manufacturing the same may be identical to the embodiment of FIG. 1 and FIG. 2, so they are not described in detail here.

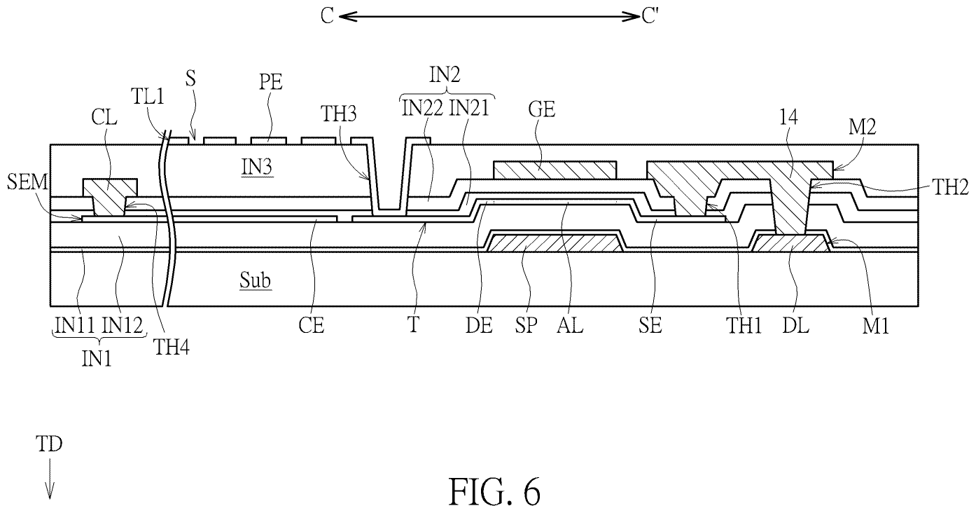

FIG. 5 schematically illustrates a top view of an electronic substrate according to a third embodiment of the present disclosure, and FIG. 6 schematically illustrates a cross-sectional view taken along a sectional line C-C′ of FIG. 5. As shown in FIG. 5 and FIG. 6, the electronic substrate 3 of this embodiment differs from the electronic substrate 1 of FIG. 1 and FIG. 2 in that the common electrode CE of the electronic substrate 3 may be formed of the semiconductor material layer SEM, while the pixel electrode PE is not formed of the semiconductor material layer SEM. The common electrode CE may be separated from the drain DE, the source SE, and the active layer AL to be electrically insulated from the drain DE. In addition, the transparent conductive layer TL1 may include the pixel electrode PE electrically connected to the drain DE. For example, the insulating layer IN2 and the insulating layer IN3 may have the through hole TH3, and the pixel electrode PE may extend into the through hole TH3 and be electrically connected to the drain DE. In this embodiment, the pixel electrode PE may have a plurality of slits S, which are arranged in sequence along a direction, for example, along the second direction D2, but not limited thereto. Through the structure of the slits S, the electric field between the common electrode CE and the pixel electrode PE may rotate the liquid crystal molecules located on the electronic substrate 3.

In this embodiment, the second metal layer M2 may further include a common line CL extending along the second direction D2. The insulating layer IN2 may further have a through hole TH4 overlapping the common electrode CE and the common line CL, so that the common line CL may extend into the through hole TH4 and be electrically connected to the common electrode CE.

In the method of manufacturing the electronic substrate 3 of this embodiment, the step of forming the source SE and the drain DE may include forming the common electrode CE separated from the drain DE in the semiconductor material layer SEM. Since the method of forming the common electrode CE is similar or identical to the method of forming the pixel electrode PE in FIG. 2, it is not detailed redundantly. Other parts of the electronic substrate 3 and other steps of the manufacturing method may be identical to the embodiment of FIG. 1 and FIG. 2 or the embodiment of FIG. 3 and FIG. 4, so that they are not detailed redundantly.

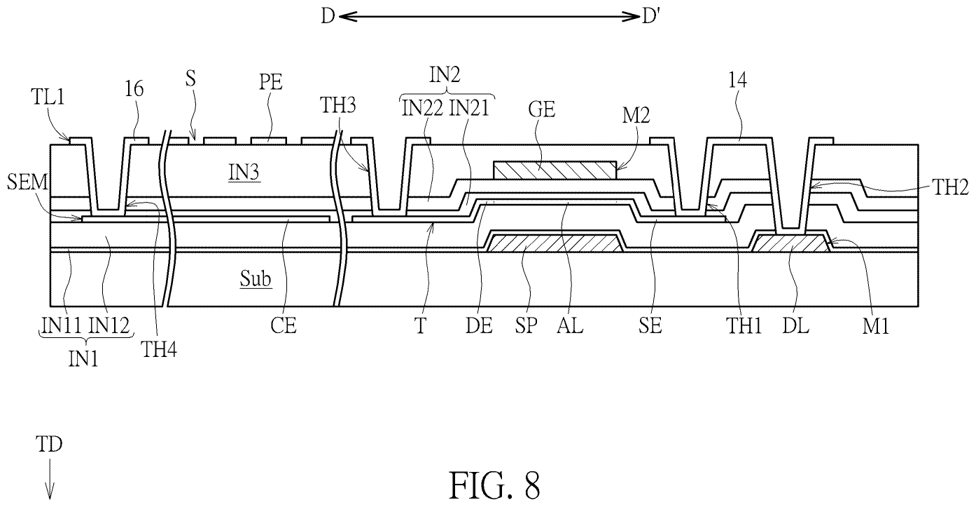

FIG. 7 schematically illustrates a top view of an electronic substrate according to a fourth embodiment of the present disclosure, and FIG. 8 schematically illustrates a cross-sectional view taken along a sectional line D-D′ of FIG. 7. As shown in FIG. 7 and FIG. 8, the electronic substrate 4 of this embodiment differs from the electronic substrate 1 of FIG. 5 and FIG. 6 in that conductive elements of the electronic substrate 4 may all be formed of the transparent conductive layer TL1. Specifically, the insulating layer IN2 and the insulating layer IN3 may have the through hole TH1 overlapping the source SE, the through hole TH3 overlapping the drain DE, and the through hole TH4 overlapping the common electrode CE, and the insulating layer IN1, the insulating layer IN2, and the insulating layer IN3 may have the through hole TH2 overlapping the data line DL. The transparent conductive layer TL1 may include the conductive element 14 and a conductive element 16, wherein the conductive element 14 may extend into the through hole TH1 and the through hole TH2 to electrically connect the source SE to the data line DL, and the conductive element 16 may extend to the through hole TH4 to be electrically connected to the common electrode CE.

In the embodiment of FIG. 7, the common line CL may be formed of the second metal layer M2, and a through hole TH5 may be provided thereon, so that the conductive element 16 may extend into the through hole TH5 to be electrically connected to the common line CL. Accordingly, the common electrode CE may be electrically connected to the common line CL through the conductive element 16. For example, the insulating layer IN3 shown in FIG. 8 may have the through hole TH5, but not limited thereto. In some embodiments, the common line CL may alternatively be formed of the first metal layer M1 or the transparent conductive layer TL1.

In the method of manufacturing the electronic substrate 4 of this embodiment, since the conductive element 14 and the conductive element 16 are formed of the transparent conductive layer TL1, the through hole TH1, the through hole TH2, the through hole TH3, the through hole TH4, and the through hole TH5 may be formed by the fifth photolithographic process. In other words, the third photolithographic process is not required, so that the manufacturing steps may be reduced, and the number of the used photomasks may be reduced to 5, thereby reducing the manufacturing cost. Other parts of the electronic substrate 4 and other steps of the method of manufacturing the same may be identical to the embodiment of FIG. 1 and FIG. 2, the embodiment of FIG. 3 and FIG. 4, or the embodiment of FIG. 5 and FIG. 6, so they are not described in detail here. In some embodiments, the conductive elements formed by the transparent conductive layer TL1 in FIG. 7 and FIG. 8 may also be applied to the conductive element 14 of FIG. 1 and FIG. 2 or the conductive element 14 of FIG. 3 and FIG. 4.

FIG. 9 schematically illustrates a top view of an electronic substrate according to a variant embodiment of the fourth embodiment of the present disclosure. As shown in FIG. 9, the electronic substrate 4a of this variant embodiment differs from the electronic substrate 4 of FIG. 7 in that the common line CL of this variant embodiment may be formed of the first metal layer M1. In FIG. 9, the common line CL may, for example, extend along the first direction D1. In this case, the insulating layers (e.g., the insulating layer IN3, the insulating layer IN2, and the insulating layer IN1 shown in FIG. 8) between the first metal layer M1 and the transparent conductive layer TL1 may have the through hole TH5. Other parts of the electronic substrate 4a and other steps of the method of manufacturing the same may be identical to those of the embodiment of FIG. 7 and FIG. 8, so that they are not described in detail here. In some embodiments, the common line CL formed of the first metal layer M1 in FIG. 9 may be applied to the electronic substrate of FIG. 1, FIG. 3 or FIG. 5.

FIG. 10 schematically illustrates a top view of an electronic substrate according to a fifth embodiment of the present disclosure. As shown in FIG. 10, the electronic substrate 5 of this embodiment differs from the electronic substrate 3 of FIG. 5 in that the scan line SL and the data line DL of this embodiment may be formed of the first metal layer M1 and the second metal layer M2, respectively. In this embodiment, the gate GE may be formed of the second metal layer M2 and be electrically connected to the scan line SL through a through hole TH6. The common line CL and the light shielding pattern SP may also be formed of the first metal layer M1. The insulating layers (e.g., the insulating layer IN1 and the insulating layer IN2 shown in FIG. 6) between the first metal layer M1 and the second metal layer M2 may have the through hole TH6. In one embodiment, the light shielding pattern SP may be directly connected to the scan line SL, for example, so that the light shielding pattern SP may be used as another gate of the transistor T, but not limited thereto. In other embodiments, the light shielding pattern SP may alternatively be separated from the scan line SL.

In the embodiment of FIG. 10, the electronic substrate 5 may not include the conductive element 14 and the through hole TH2, and the data line DL may be electrically connected to the source SE through the through hole TH1, but not limited thereto. In some embodiments, the data line DL may be electrically connected to the source SE through the conductive element. Other parts of the electronic substrate 5 and other steps of the method of manufacturing the same may be identical to those of the embodiments of FIG. 5 and FIG. 6, so they will not be described in detail herein. In some embodiments, the structures of the scan line SL and the data line DL of FIG. 10 may be applied to the scan line SL and the data line DL of FIG. 1 or FIG. 3.

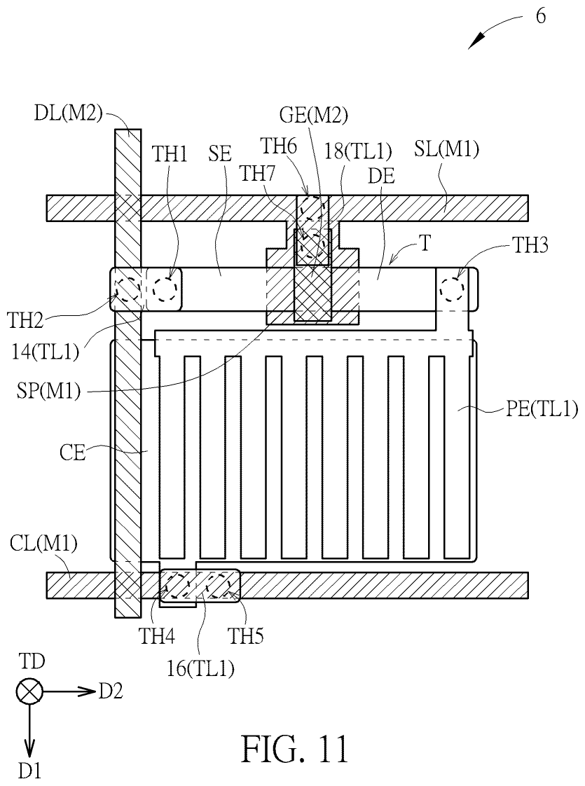

FIG. 11 schematically illustrates a top view of an electronic substrate according to a sixth embodiment of the present disclosure. As shown in FIG. 11, the electronic substrate 6 of this embodiment differs from the electronic substrate 5 of FIG. 10 in that the conductive elements of the electronic substrate 6 may all be formed of the transparent conductive layer TL1. Specifically, the transparent conductive layer TL1 may include the conductive element 14, the conductive element 16, and a conductive element 18, wherein the conductive element 14 may extend into the through hole TH1 and the through hole TH2 to electrically connect the source SE to the data line DL, the conductive element 16 may extend into the through hole TH4 and the through hole TH5 to electrically connect the common electrode CE to the common line CL, and the conductive element 18 may extend into the through hole TH6 and the through hole TH7 to electrically connect the gate GE to the scan line SL.

In the embodiment of FIG. 11, the insulating layers (e.g., the insulating layer IN2 and the insulating layer IN3 shown in FIG. 8) between the semiconductor material layer and the transparent conductive layer TL1 may have the through hole TH1, the through hole TH3, and the through hole TH4, the insulating layers (e.g., the insulating layer IN3 shown in FIG. 8) between the second metal layer M2 and the transparent conductive layer TL1 may have the through hole TH2 and the through hole TH7, and the insulating layers (e.g., the insulating layer IN1, the insulating layer IN2, and the insulating layer IN3 shown in FIG. 8) between the first metal layer M1 and the transparent conductive layer TL1 may have the through hole TH5 and the through hole TH6, but not limited thereto.

In the method of manufacturing the electronic substrate 6 of this embodiment, since the conductive element 14, the conductive element 16, and the conductive element 18 may be formed of the transparent conductive layer TL1, the through hole TH1, the through hole TH2, the through hole TH3, the through hole TH4, the through hole TH5, the through hole TH6, and the through hole TH7 may be formed by the fifth photolithographic process. In other words, the third lithography process may not be required, so that the manufacturing steps may be reduced, and the number of photomasks may be saved. Other parts of the electronic substrate 6 and other steps of the method of manufacturing the same may be identical to the embodiment of FIG. 1 and FIG. 2, the embodiment of FIG. 3 and FIG. 4 or the embodiment of FIG. 5 and FIG. 6, so they are not described in detail here.

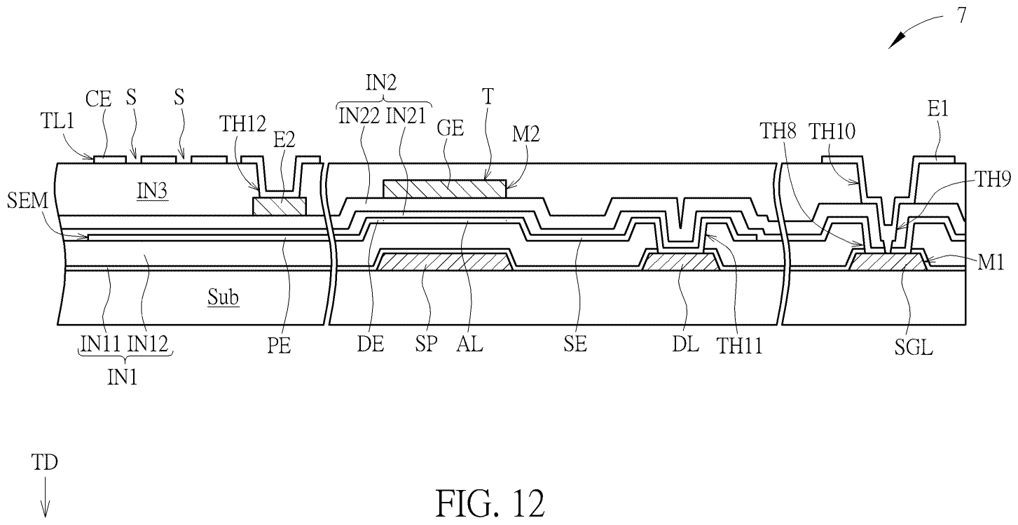

FIG. 12 schematically illustrates a cross-sectional view of an electronic substrate according to a seventh embodiment of the present disclosure. As shown in FIG. 12, the electronic substrate 7 provided by this embodiment differs from the electronic substrate 1 of FIG. 2 in that the first metal layer M1 may further include a signal line SGL electrically insulated from the data line DL, such that the signal line SGL may be used to transmit a signal different from the data signal in the data line DL. For example, the signal line SGL may be a common line, a bias signal line, sensing signal line or other suitable signal lines. For instance, the signal line SGL may be the sensing signal line for transmitting light sensing signal or touch sensing signal.

In the embodiment of FIG. 12, the transparent conductive layer TL1 may further include an electrode E1 electrically connected to the signal line SGL. For example, the insulating layer IN1 may have a through hole TH8, such that a portion of the insulating layer IN2 may be disposed in the through hole TH8. The insulating layer IN2 may further have a through hole TH9 exposing the signal line SGL, and the insulating layer IN3 may further have a through hole TH10 overlapping the through hole TH8, such that the electrode E1 may be disposed in the through hole TH10 and the through hole TH9 and contact the signal line SGL. In this embodiment, an aperture of the through hole TH10 may be greater than an aperture of the through hole TH9, and the through hole TH9 may be located in the through hole TH8, but not limited thereto.

In some embodiments, the electronic substrate 7 may not include the conductive element 14, the through hole TH1 and the through hole TH2, and the insulating layer IN1 may have a through hole TH11 overlapping the data line DL, so that the source SE may be electrically connected to the data line DL through the through hole TH11.

In some embodiments, the second metal layer M2 may further include an electrode E2 separated from the gate electrode GE, and the electrode E2 may overlap the pixel electrode PE. The insulating layer IN3 may further have a through hole TH12 overlapping the electrode E2, and the common electrode CE may be electrically connected to the electrode E2 through the through hole TH12, so that the electrode E2 and the pixel electrode PE may be coupled to form a storage capacitor.

In the manufacturing method of the electronic substrate 7 in this embodiment, since the signal line SGL is included in the first metal layer M1, it may be formed by the first photomask and the first photolithographic process. Different from the embodiment of FIG. 2, the step of forming the insulating layer IN1 may include performing an eighth photolithographic process in combination with an eighth photomask to form the through hole TH8 and the through hole TH11 in the insulating layer IN1, and the step of forming the insulating layer IN2 may include performing a ninth photolithographic process in combination with a ninth photomask to form the through hole TH9 in the insulating layer IN2. Furthermore, since the electronic substrate 7 does not include the conductive element, the through hole TH1 and the through hole TH2, the method of this embodiment may omit the third photomask and the third photolithographic process of the above embodiment.

In addition, since the electrode E2 is included in the second metal layer M2, it may be formed by the fourth photomask and the fourth photolithographic process. Furthermore, the through hole TH10 and the through hole TH12 of the insulating layer IN3 may be formed by the fifth photomask and the fifth photolithographic process. Other parts of the electronic substrate 7 and other steps of the manufacturing method may be identical to those in the embodiment of FIG. 1 and FIG. 2 and thus will not be described in detail herein.

In summary, in the electronic substrate of the present disclosure, since the signal line may be formed of the first metal layer and be directly disposed on the upper surface of the substrate, uneven etching to the signal line due to being formed on uneven surface may be reduced or avoided. In this way, in the case that the line width of the signal line is reduced, the line breakage may be reduced to improve the product yield. In addition, in the method of manufacturing the electronic substrate of the present disclosure, since the data line, the light shielding pattern, the pixel electrode, the source, the drain, the scan line, the gate, the common electrode, and the conductive elements may be formed of at least the first metal layer, the semiconductor material layer, the second metal layer, and the transparent conductive layer, the manufacturing steps may be significantly simplified, and the number of the used photomasks may be decreased to reduce the manufacturing cost.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. An electronic substrate, comprising:
a substrate;
a transistor disposed on the substrate, and the transistor comprising an active layer, a source, a drain, and a gate disposed on the active layer, wherein the active layer is disposed between the source and the drain and overlaps the gate, and the active layer, the source, and the drain are formed of a semiconductor material layer;
a data line disposed on the substrate and electrically connected to the transistor; and
a conductive element disposed on the data line and the semiconductor material layer and electrically connected to the data line and the source.

2. The electronic substrate according to claim 1, wherein the source and the drain comprise dopants.

3. The electronic substrate according to claim 1, wherein a conductivity of one of the source and the drain is greater than a conductivity of the active layer.

4. The electronic substrate according to claim 1, wherein the semiconductor material layer comprises metal oxide.

5. The electronic substrate according to claim 1, wherein the data line is formed of a first metal layer, the gate and the conductive element are formed of a second metal layer, and the second metal layer is disposed on the first metal layer.

6. The electronic substrate according to claim 1, further comprising a scan line disposed on the substrate and electrically connected to the gate of the transistor, wherein the scan line is formed of a first metal layer, the data line and the gate are formed of a second metal layer, and the second metal layer is disposed on the first metal layer.

7. The electronic substrate according to claim 1, further comprising a pixel electrode electrically connected to the transistor, wherein the pixel electrode is formed of the semiconductor material layer.

8. The electronic substrate according to claim 1, further comprising a pixel electrode electrically connected to the transistor, wherein the pixel electrode and the conductive element are formed of a transparent conductive layer.

9. The electronic substrate according to claim 8, further comprising a common electrode, wherein the common electrode is formed of the semiconductor material layer.

10. The electronic substrate according to claim 8, further comprising a common electrode, wherein the common electrode is formed of another transparent conductive layer, and the another transparent conductive layer is disposed on the transparent conductive layer.

11. A method of manufacturing an electronic substrate, comprising:
providing a substrate;
forming a first metal layer on the substrate, wherein the first metal layer comprises a data line;
forming a first insulating layer on the first metal layer;
forming a semiconductor material layer on the first insulating layer;
forming a second insulating layer on the semiconductor material layer;
forming a second metal layer on the second insulating layer, wherein the second metal layer comprises a scan line, and the scan line comprises a gate; and
forming a source and a drain in the semiconductor material layer, wherein the semiconductor material layer comprises an active layer, and the active layer is disposed between the source and the drain;
wherein in a cross-sectional view of the electronic substrate, the gate overlaps the active layer, and the scan line is disposed on the data line.

12. The method of manufacturing the electronic substrate according to claim 11, wherein the source and the drain are formed after forming the second metal layer, and forming the source and the drain comprises introducing dopants into portions of the semiconductor material layer without overlapping the scan line.

13. The method of manufacturing the electronic substrate according to claim 11, wherein a conductivity of one of the source and the drain is greater than a conductivity of the active layer.

14. The method of manufacturing the electronic substrate according to claim 11, wherein the semiconductor material layer comprises metal oxide.

15. The method of manufacturing the electronic substrate according to claim 11, wherein the second metal layer further comprises a conductive element electrically connected to the data line and the source.

16. The method of manufacturing the electronic substrate according to claim 11, wherein forming the source and the drain comprises forming a pixel electrode in the semiconductor material layer.

17. The method of manufacturing the electronic substrate according to claim 11, further comprising forming a third insulating layer on the second metal layer and forming a transparent conductive layer on the third insulating layer, wherein the transparent conductive layer comprises a pixel electrode electrically connected to the drain.

18. The method of manufacturing the electronic substrate according to claim 17, wherein the transparent conductive layer further comprises a conductive element electrically connected the data line and the source.

19. The method of manufacturing the electronic substrate according to claim 17, wherein forming the source and the drain comprises forming a common electrode in the semiconductor material layer, and the common electrode is separated from the drain.

20. The method of manufacturing the electronic substrate according to claim 11, further comprising forming a third insulating layer on the second metal layer and forming a transparent conductive layer on the third insulating layer, wherein the transparent conductive layer comprises a common electrode.
